(19) United States
(12) Patent Application Publication
(10) Pub. No.: US 2019/0077382 A1
(43) Pub. Date: Mar. 14, 2019

(54) Tire Pressure Transfer Hose Assembly

(71) Applicant: Jason Chance Newburn, Bryant, AR (US)

(72) Inventor: Jason Chance Newburn, Bryant, AR (US)

(21) Appl. No.: 15/963,286

(22) Filed: Apr. 26, 2018

Related U.S. Application Data
(60) Provisional application No. 62/606,175, filed on Sep. 12, 2017.

(51) Int. Cl. B60S 5/04

(52) U.S. Cl. CPC B60S 5/04

(57) ABSTRACT

A hose assembly utilizing an internal lumen connecting multiple end ports, with one end port of the assembly configured to be connected to the air stem of a deflated tire and the other end port (or ports if there are more than two) are configured to be connected to the air stem of one or more additional tires of higher pressure, such that upon the opening of the end ports, air is transferred through the internal lumen from the higher pressure tire(s) until a sufficient amount of air has been input into the deflated tire to allow usage of the vehicle. Various configurations including a single, straight hose configuration or various branched configurations may be used to transfer air between tires in different situations.

### CROSS-REFERENCE TO RELATED APPLICATIONS

This application claims the benefit of U.S. Provisional Patent Application No. 62/606,175, entitled “Clamp and go air hose” and filed on Sep. 12, 2017. Such application is hereby incorporated by reference in its entirety.

### STATEMENT REGARDING FEDERALLY SPONSORED RESEARCH OR DEVELOPMENT

Not applicable.

### BACKGROUND OF THE INVENTION

According to national statistics, there were approximately 270 million vehicles registered for use in the United States. These vehicles include cars, motorcycles, buses, trucks, among others. It is also estimated that in 2017, another 6.5 million vehicles were sold to consumers. That means on any given day that there are hundreds of million tires on the road. And the more tires that hit the road every day, the more opportunity there is for those tires to go flat-many due to slow leaks caused by minor punctures. In fact, it is estimated by some that there are about 220 million flat tires per year—about 7 flats every second. It is also estimated that nearly 60% of Americans do not know how to change a flat tire. Instead, many people rely on costly and time-consuming road side services or just drive on their flat tire, potentially causing serious damage to their vehicle or causing accidents with other drivers. A simple and inexpensive device that these 60% of Americans and even those who do know how to change a flat can use to temporarily resolve flat tire issues so that the vehicle can be safely moved to a mechanic for tire repair is needed.

### BRIEF SUMMARY OF THE INVENTION

Generally speaking, the present invention is directed to a device useful for temporary repair of flat tires, and more particularly to a hose and clamp assembly for connecting to a number of tires of a vehicle that provides a means for transferring air between the tires. It is an object of the present invention to provide a device that allows the air pressure in a underinflated tire to be increased by transferring the air from a separate tire (or multiple tires) with sufficient air to the underinflated tire. It may be seen, then, that a flat tire may be temporarily remedied without requiring expensive air pumps, oversized compressors, or other pumping devices, but instead, is temporarily remedied through a simple connection of the underinflated tire to a second or multiple other tires. Because of the simple nature of the device, the device may be used in situations where electrical pumping devices cannot be used, such as when the user is stranded on a remote highway or other situations.

These and other objects, features, and advantages of the present invention will become better understood from a consideration of the following detailed description of the preferred embodiments and appended claims in conjunction with the drawings as described following:

### BRIEF DESCRIPTION OF THE DRAWINGS

FIG. 1 shows one embodiment of the device of the present invention.

FIG. 2 shows one alternative embodiment of the device of the present invention, the device having a number of hoses extending from a central branching point.

FIG. 3 shows one alternative embodiment of the device of the present invention, the device having a number of hoses extending from a branching point, with one branch substantially longer than the remaining branches.

FIG. 4 shows one alternative embodiment of the device of the present invention, the device having hoses extending from multiple branching points separated by a length of hose.

### DETAILED DESCRIPTION OF THE INVENTION

Generally speaking, the present invention is directed to a device useful for temporary repair of flat tires, and more particularly to a hose and clamp assembly for connecting to a number of tires of a vehicle that provides a means for transferring air between the tires. For purposes of describing the device of the present invention, some aspects of the invention may be described with regard to being useful for transferring air between two or more tires on a truck or care or multiple trucks or cars. It is understood, however, that the pressure exchanging device of the present invention is useful for donating air pressure from any higher pressure tire to any lower pressure tire regardless of the type of structure to which the tires are attached.

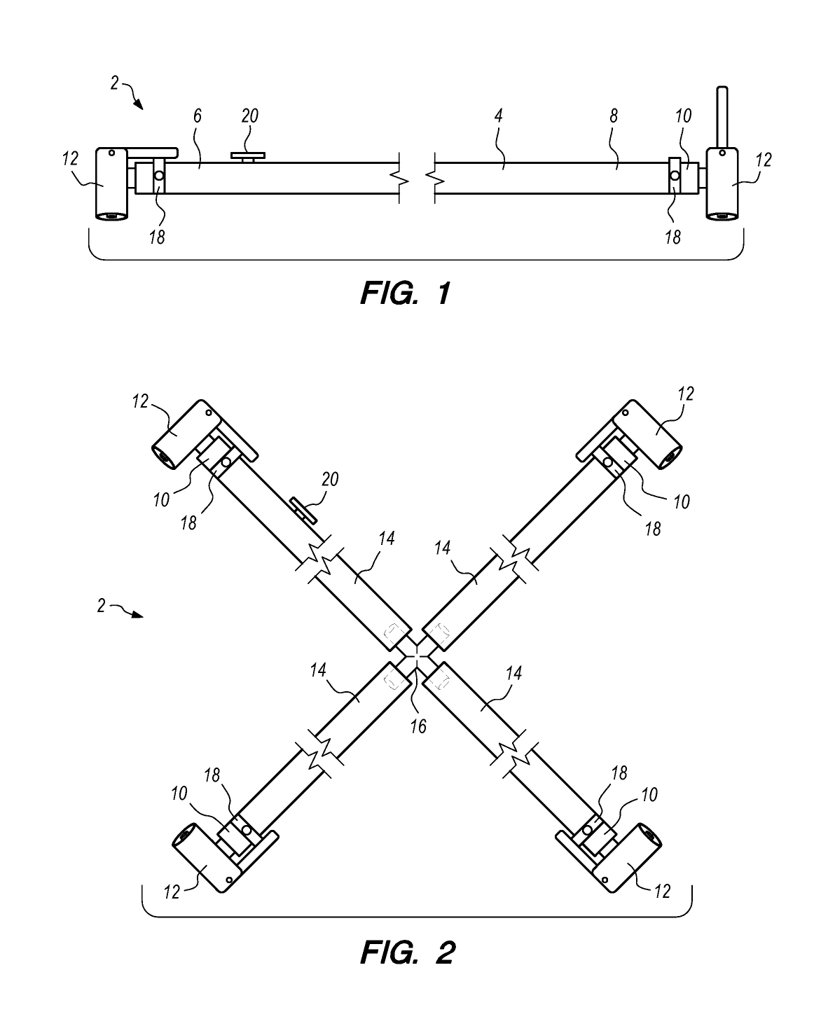

Turning to FIG. 1, one embodiment of an air pressure exchanging device 2 of the present invention may be described. The air pressure exchanging device 2 generally includes an elongated, flexible hose 4 having a donating end 8 and a receiving end 6. The hose 4 includes an internal lumen extending the length of the hose 4 between the donating end 8 and the receiving end 6. The lumen serves as a passageway for the transfer of air from a donating tire to a receiving tire by attaching the donating end 8 of the hose 4 to the donating tire and the receiving end 6 of the hose 4 to the receiving tire. The lumen is preferably a quarter inch in diameter, but other sizes may be used so long as air may flow through the hose 4 unimpeded. A difference in pressure between the two tires facilitates a transfer of air from the donating tire to the receiving tire through the hose 4, as described below. In the preferred embodiment, the hose 4 has a sufficient length such that the hose 4 may be used with different size vehicles so that the purchase of a single device 2 by the user allows the user to temporarily repair the air pressure in a deflated tire for any vehicle the user drives. A hose 4 length of approximately twenty feet is preferred. Still, different embodiments intended to be limited to particular uses may utilize shorter or longer hoses 4. For example, a device 2 with a shorter hose 4 may be used as an on-the-go air transfer tool for cycling. The cyclist can connect the device 2 to his or her flat tire and receive air from a nearby vehicle or other cyclist. Similar short devices 2 can be used with other vehicles, such as personal or commercial landscaping machines, or any other vehicle with air tires.

In the preferred embodiment, the receiving end 6 of the hose 4 and the donating end 8 of the hose 4 each have an end port 10 where the hose 4 is connected to the tire and through which air is able to enter or exit the hose 4. In order to facilitate a secure fit onto the valve stem of a tire, the end ports 10 may include a clamped connector 12, which is preferably a valve clamp. The clamp connector 12 allows the end ports 10 to be selectively positioned in an open position or a closed position (as shown in FIG. 1), such that the user can manually stop and start air flow through the end point 10. In the preferred embodiment, the open position corresponds to the clamp 12 being in the compressed position such that a valve 18 associated with that particular end of the hose 4 is pressed down allowing airflow through the end port (see receiving end 6 of the device 2 in FIG. 1). The end port 10 is set in the closed position by unclamping the clamped connector 12 such that the valve 18 closes and air flow is impeded through the end port 10 (see the donating end 8 of the device 2 in FIG. 1). In the preferred embodiment, both the receiving end 6 and donating end 8 utilize a clamp connector 12 such that air flow through each end may be open or closed independently. This allows the user to attach one end to the appropriate tire with the end port 10 in the closed position such that air is not lost from the tire during the time when the user is connecting the opposite end to a different tire. Each of the clamp connectors 12 is preferably individually controllable such that the open or closed nature of each end port 10 can be individually selected. Furthermore, it is preferred that the clamp connectors 12 are in the “normally closed” position (meaning that the end port 10 is closed when the clamp is in its normal, uncompressed state) so as to limit air loss from the tire during connection of the device 2 to the tire. A gauge 20 (or multiple gauges 20) may be connected to the device 2 in order to measure the air pressure transferred through the device 2.

Having described the preferred embodiment of the device 2 of the present invention, the following example is described for purposes of describing the preferred use of the device 2. As indicated above, the device is used to connect a receiving tire to a donating tire. The receiving tire is generally characterized as a tire having some sort of hole or puncture that has caused some deflation of the tire. The donating tire is generally characterized as a tire having more air than the receiving tire and having sufficient air such that a transfer of a portion of the donating tire's air to the receiving tire results in both the donating tire and receiving tire having sufficient air for vehicle mobility. Thus, it may be seen that the donating tire transfers a small portion of air to the receiving tire such that the air in both tires reaches an equilibrium and both tires have an amount of air somewhere in between the high end amount (amount originally in donating tire) and the low end amount (amount originally in the receiving tire). For example, if a user has determined that one of the tires on his or her vehicle has deflated to 14 psi due to a slow leak or other issue, the user can connect the air pressure exchanging device 2 to another tire on his or her vehicle (or, with permission, to a nearby vehicle) having a tire pressure of 34 psi, resulting in a total pressure between the two tires of 48 psi. Air is transferred through the lumen of the device 2 from the higher pressure tire (donating tire) to the lower pressure tire (receiving tire) until either an equilibrium is met or until the user disconnects the device 2. Equilibrium is described as the point in which the air in both tires equalizes such that no transfer of air is occurring in the hose. For example, in the scenario described above, equilibrium is met when both tires reach 24 psi, thus providing each tire with sufficient air to drive to a nearby mechanic or air pump for fixing any tire defects in the receiving tire and resupplying air to both tires to a psi within the appropriate range (for most consumer vehicles, for example, the preferred range is 32 to 35 psi).

Because the deflated tire is receiving air from another tire, it is important that the donating tire have sufficient air to provide enough air to the receiving tire without the donating tire itself deflating to a point under a safe amount. For example, take a situation where the deflated tire has gone almost completely flat and only has 4 psi and the higher pressure tire has 35 psi, for a total available air pressure between both tires of 39 psi. Once the device 2 of the present invention has been connected to both tires and air has transferred from the donating tire to the receiving tire until equilibrium has been reach, each tire will have a final pressure 19.5 psi. Unfortunately, this is an insufficient air pressure to be driven on without risking damage to the vehicle or increasing the risk of an accident. In such a case, the benefit of transferring air from the donating tire to the receiving tire is not recognized. In such a scenario, it would be useful to allow a transfer of air from multiple donating tires to the deflated receiving tire. Take, for example, the scenario above where the deflated tire has almost entirely deflated, having a pressure of only 4 psi. However, instead of having only one donating tire having 35 psi, there are three donating tires each with 35 psi. Thus, instead of having a total pressure of 39 psi, there is a total pressure of 109 psi. Once the air transfer has taken place and equilibrium has been met, each of the four tires will have a pressure of 27.25 psi. While this number is outside of the desired range, it is much closer to the desired range than when only one donating tire is used—and would substantially reduce the risk of harm to the vehicle. As such, the vehicle can now be moved to a location where the defected tire can be repaired and air can be resupplied to all of the tires. Thus, in certain scenarios, it may be more beneficial to allow the deflated receiving tire to receive air from multiple donating tires.

Various alternative embodiments of the present invention, as shown in FIGS. 2-4, allow for the transfer of air from multiple donating tires to a deflated receiving tire. While each of these various embodiments can generally be described in substantially similar terms as the prior described embodiment, the functionality of each of the various embodiments varies slightly, as each of the various embodiments is particularly useful in a unique situation. Generally speaking, like the two-tire embodiment described above, the various alternative embodiments utilize a similar hose and connector configuration. Unlike the previously described embodiment, however, the various alternative embodiments of the present invention utilize multiple hoses connected in branched configurations to provide utility in different scenarios. In general, the branching may be facilitated by manufacturing the tubes in a single, branched piece or may be facilitated by combining multiple individual hoses using branched connectors 16. In either case, the device includes a number of hoses, each fluidically connected by an internal lumen, such that air my flow through the hose between the end ports 10 of all of the interconnected tubes. If desired, the different tubes may be removably attached together using the branching connector 16 such that the device may be modified by the user to fit certain needs.

In one embodiment, as shown in FIG. 2, the air transfer device 2 includes multiple air hose branches 14 extending from a centralized point in a radial direction. Each of the air hose branches 14 includes an end port 10 having a clamped connection 12, which functions substantially similar to the clamped connection 12 described previously. The other end of each air hose branch 14 is connected to the other air hose branches 14 at a central location, which may be facilitated by an air flow splitter 16 or may be facilitated by the manufacturer of the tubing in such a configuration, as indicated above. In the preferred embodiment, all of the air hose branches 14 have a substantially equal length, therefore allowing the end ports 10 of each hose branch 14 to be positioned at spaced apart positions from the central point of the device 2 at equal distances from the central point. This makes this particular embodiment particular useful for single-car operations, where the device 2 can be used by the user to connect multiple tires of the user's own vehicle to transfer air from multiple donating tires to a single deflated receiving tire. In the preferred embodiment, each of the hose branches 14 extends approximately 10 feet from the central connection point. In one embodiment, a magnet may be integrated into the device 2 at the central connection point (for example, the air splitter 16 may be manufactured from a magnetic material) such that, as the hose branches 14 extend from one side of a vehicle to the other side (and thus the central connection point is positioned over or under the vehicle), the magnet allows the central connection point to remain in a substantially central location on the vehicle so that each of the hose branches 14 is capable of reaching a tire in different a different corner of the vehicle. A gauge 20 or multiple gauges 20 may be included with the device 2 to provide for measurement of air pressure, with the preferred placement of the gauge 20 being on the branch hose 14 to be connected to the receiving tire.

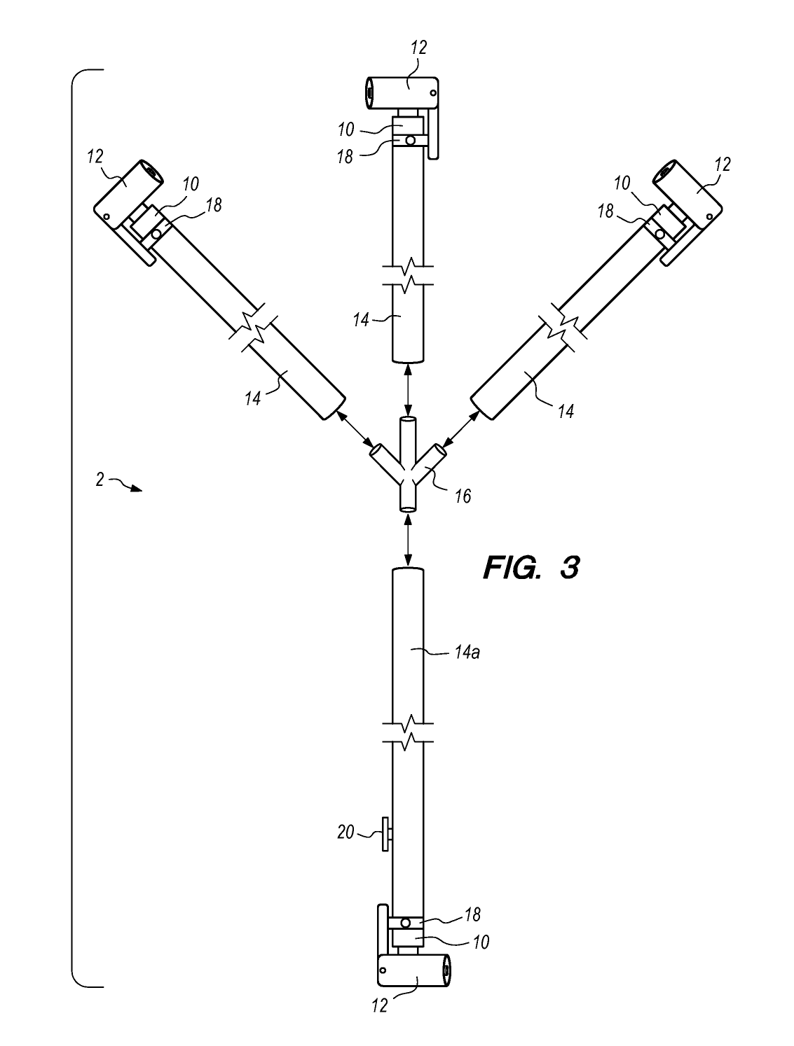

Another alternative embodiment of the present invention implementing the branched configuration is shown in FIG. 3. This particular embodiment functions in a substantially similar manner as the embodiment shown in FIG. 2. However, as shown in FIG. 3, in one embodiment one of the hose branches 14a may be substantially longer than the other branches 14. It is intended that the longer hose branch 14a be connected to the receiving tire. This allows a receiving tire to be connected to multiple donating tires that are positioned at a longer distance from the receiving tire. This may be particularly useful, for example, when a tire of one vehicle has been deflated but none of the remaining tires on the vehicle has sufficient air to donate to the deflated tire. Instead, the deflated receiving tire may be connected through the elongated branch 14a to multiple donating tires on another vehicle (such as a friendly passing motorist) with tires having sufficient pressure to donate to the deflated receiving tire of the first vehicle. As with the previous described embodiments, the hose is a flexible hose having an internal lumen for transferring air between the tires. Furthermore, the receiving end and each of the donating ends may include the clamping connector 12 to allow for the control of flow into and out of the end ports 10. A psi gauge 20 may be included on the elongated branch 14a to allow for monitoring of air flow into the receiving tire.

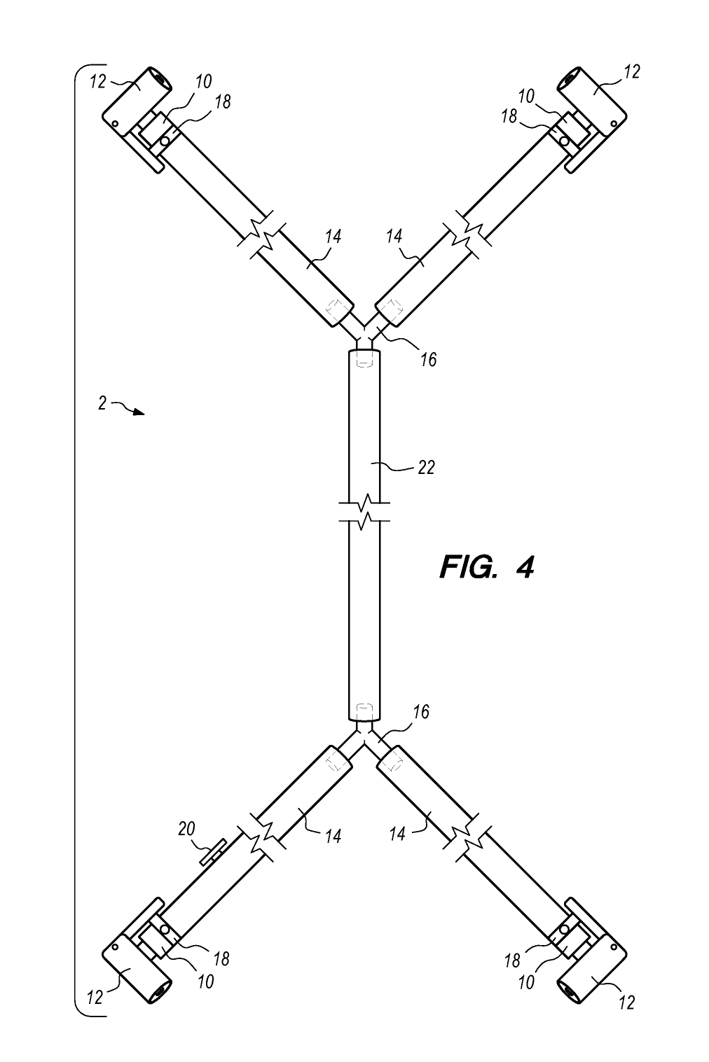

Another alternative embodiment of the air transfer device 2 of the present invention is shown in FIG. 4. As with the embodiments shown in FIGS. 2-3, the embodiment shown in FIG. 4 utilizes a branched configuration. Like the embodiments discussed previously, the embodiment shown in FIG. 4 uses an internal lumen of a flexible hose to transfer air between end ports 10 connected to tires. The branching configuration may be created through a single, manufactured piece or, as described above, may include a number of tubes 14 connected via a branched air splitter 16. As shown in FIG. 4, multiple branching locations may be used, with the different branching locations positioned at different ends of the device 2. A portion of flexible hose 22 is extended between the two branching locations, providing for two branched ends positioned at a distance substantially a part. In the preferred embodiment, for example, the flexible hose portion 22 connecting the two branching ends is approximately 10 feet. The branching points provide a location where multiple smaller hoses 14 may branch from the larger connecting hose 22. As with the embodiments above, each of these smaller hoses 14 includes an end port 10 (and a clamped connector 12) that allow the particular hose branch 14 to be connected to a tire. It may be seen, then, that this particular embodiment is useful for longer vehicles, where the front set of tires is a substantial distance from the back set of tires (such as a bus, tractor trailer, or other elongated vehicle). This particular arrangement allows the device 2 to be connected to multiple donating tires such that each tire can donate a portion of its air to the deflated tire.

The flexible hose material of the present invention is preferably a rubber material, allowing for the hose to be flexible but durable. In one embodiment, the flexible air transfer hose may be included in a kit that includes the air transfer device and materials for patching the defected tire.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a Markush group or other grouping is used herein, all individual members of the group and all combinations and subcombinations possible of the group are intended to be individually included. All references cited herein are hereby incorporated by reference to the extent that there is no inconsistency with the disclosure of this specification. When a range is stated herein, the range is intended to include all sub-ranges within the range, as well as all individual points within the range. When “about,” “approximately,” or like terms are used herein, they are intended to include amounts, measurements, or the like that do not depart significantly from the expressly stated amount, measurement, or the like, such that the stated purpose of the apparatus or process is not lost.

The present invention has been described with reference to certain preferred and alternative embodiments that are intended to be exemplary only and not limiting to the full scope of the present invention, as set forth in the appended claims.

1. A device for transferring air from at least one donating tire having a donating tire pressure to a receiving tire having a receiving tire pressure, the device comprising:
a. a hose assembly comprising a first end and a second end and at least one hose extending from the first end to the second end;
b. an internal lumen inside the at least one hose and extending from the first end of the hose assembly to the second end of the hose assembly;
c. a receiving end port at the first end of the hose assembly; and
d. a first donating end port at the second end of the hose assembly;
wherein the receiving end port is configured to be fluidically connected to the receiving tire, further wherein the first donating end port is configured to be fluidically connected to a first donating tire, thereby transferring air from the first donating tire to the receiving tire until the donating tire pressure and the receiving tire pressure equalize.

2. The device of claim 1, further comprising a clamping device positioned at the receiving end port, wherein the clamping device is configured to open and close the receiving end port.

3. The device of claim 1, further comprising a clamping device positioned at the first donating end port, wherein the clamping device is configured to open and close the first donating end port.

4. The device of claim 1, further comprising a first branching point located between the first end and second end of the hose assembly.

5. The device of claim 4, comprising a first branching hose having a first end and a second end, wherein the first end of the first branching hose is connected to the hose assembly at the first branching point and wherein the second end of the first branching hose is configured to be connected to the receiving tire through the receiving end port.

6. The device of claim 5, comprising a second branching hose having a first end and a second end, wherein the first end of the second branching hose is connected to the hose assembly at the first branching point and wherein the second end of the second branching hose is configured to be connected to the first donating tire through the first donating end port.

7. The device of claim 6, comprising a third branching hose having a first end and a second end, wherein the first end of the third branching hose is connected to the hose assembly at the first branching point and wherein the second end of the third branching hose is configured to be connected to a second donating tire through a second donating end port.

8. The device of claim 7, further comprising a fourth branching hose having a first end and a second end, wherein the first end of the fourth branching hose is connected to the hose assembly at the first branching point and wherein the second end of the fourth branching hose is configured to be connected to a third donating tire through a third donating end port.

9. The device of claim 6, further comprising a second branching point located between the first end and second end of the hose assembly, wherein the first branching point and the second branching point are separated by a length of hose.

10. The device of claim 9, comprising a third branching hose having a first end and a second end, wherein the first end of the third branching hose is connected to the hose assembly at the second branching point and wherein the second end of the third branching hose is configured to be connected to a second donating tire through a second donating end port.

11. The device of claim 10, further comprising a fourth branching hose having a first end and a second end, wherein the first end of the fourth branching hose is connected to the hose assembly at the second branching point and wherein the second end of the fourth branching hose is configured to be connected to a third donating tire through a third donating end port.

12. The device of claim 4, further comprising a magnet positioned at the first branching point.

13. The device of claim 4, further comprising a first air splitter positioned at the first branching point.

14. The device of claim 13, wherein the first air splitter is configured to removably connect a number of branching hoses to the hose assembly at the first branching point.

15. The device of claim 9, further comprising a magnet positioned at the second branching point.

16. The device of claim 9, further comprising a second air splitter positioned at the second branching point.

17. The device of claim 16, wherein the second air splitter is configured to removably connect a number of branching hoses to the hose assembly at the second branching point.
